(19) United States
(12) Patent Application Publication
(10) Pub. No.: US 2012/0066007 A1
(43) Pub. Date: Mar. 15, 2012

(54) System and Method for Tracking and Sharing Driving Metrics with a Plurality of Insurance Carriers

(76) Inventors: David P. Ferrick, Lexington, MA (US); Tod Farrell, Coppell, TX (US); Gary Wallace, Euless, TX (US)

(21) Appl. No.: 13/231,469

(22) Filed: Sep. 13, 2011

Related U.S. Application Data
(60) Provisional application No. 61/382,558, filed on Sep. 14, 2010.

(51) Int. Cl. G06Q 40/00

(52) U.S. Cl. 705/4

(57) ABSTRACT

A method for determining an insurance premium cost to insure a vehicle. A wireless communication link exists between a vehicle telematics system of the vehicle and a control center remote from the vehicle. The control center has a data center including a database server and a protocol gateway exchanging data with the server, and a web portal connected to the data center. Driver metrics data associated with the vehicle and/or the driver are communicated by a vehicle telematics system to the data center and are analyzed to create a driver profile. The driver profile is shared with at least one insurance carrier who can assign a rating to the profile and, thereby, determines an insurance premium cost to insure the vehicle, which is sent to an owner or a driver of the vehicle.

### CROSS-REFERENCE TO RELATED APPLICATIONS

This application claims priority, under 35 U.S.C. §119, to U.S. Provisional Patent Application Ser. No. 61/382,558, filed on Sep. 14, 2010, the entire disclosure of which is hereby incorporated herein by reference in its entirety.

### STATEMENT REGARDING FEDERALLY SPONSORED RESEARCH OR DEVELOPMENT

Not Applicable.

### FIELD OF THE INVENTION

The present invention relates generally to achieving insurance premiums that are correlated to a driver's driving metrics, and more particularly relates to a system and method for determining a driving profile based on driving metrics and allowing multiple insurance carriers to view and bid on insurance coverage based on the profile.

### BACKGROUND OF THE INVENTION

Traditionally, automobile insurance carriers determine insurance premiums based on an “aggregate” pricing model. That is, the insurance carrier creates a predictive pricing model for a particular group of drivers. It is assumed that the group will include, at one end, very safe drivers and, at an opposite end, unsafe drivers. Between these ends are drivers that are assumed to exercise varying levels of driving safety. After defining the group, the insurance carrier then sets a price for premiums that allows it to provide payouts for predicted claims, while also making a profit.

The aggregate pricing model suffers from the disadvantage that safe drivers are unfairly forced to pay increased premiums based on predicted claims of the unsafe drivers in their group. On the other hand, reckless drivers within the group are allowed to pay premiums that are disproportionately lower than their driving style should allow.

Recently, at least one insurance company has introduced what is called “usage-based insurance,” also known as “pay as you drive” (PAYD), which is a type of automobile insurance where the costs are dependent upon specific metrics, including how, how much, and where a person drives. The PAYD insurance model allows insurance premiums to be calculated dynamically rather than on a predictive aggregate model.

More specifically, the PAYD insurance model sets insurance premiums based on factors such as the number of miles a vehicle travels in a defined period of time, the amount of time the vehicle is in use, the time of day the vehicle is driven, and the range of speeds the vehicle is driven.

Currently, to participate in the PAYD insurance model, the insured must obtain coverage from a particular carrier and, only then, can they arrange for the carrier to monitor their vehicle. That is, each insurance carrier offering the PAYD insurance model utilizes their own equipment for obtaining the driver's driving metrics. Once a driver obtains coverage from the insurance carrier, a period of time must pass while the insurance carrier collects the driver's driving metrics. After that period of time elapses, i.e., once sufficient data has been collected, the insurance carrier can present a premium price to the insured that accounts for the insured's determined driving metrics.

Unfortunately, the insured is confined to that particular carrier's pricing decision, which they will only know after obtaining coverage from that carrier and waiting the requisite data-collection time. If a driver is interested in shopping for better pricing from another insurer offering the PAYD insurance model, that driver is forced to obtain coverage from a competing carrier, wait for that carrier to collect sufficient driving metrics, and only then can the driver evaluate that carrier's pricing. This makes the collection of data of very little value to one shopping for an optimum insurance quote.

Thus, a need exists to overcome the problems with the prior art systems, designs, and processes as discussed above.

### SUMMARY OF THE INVENTION

The present invention provides a novel and efficient system and method for obtaining metrics pertaining to a driver's driving habits that overcome the hereinafore-mentioned disadvantages of the heretofore-known devices and methods of this general type and, at the same time, dynamically create a vehicle or driver profile based on the collected driving metrics that is able to be shared with any number of participating insurance carriers. Advantageously, multiple insurance carriers are able to utilize the driving profile and determine an insurance premium cost that correlates with aspects of the driving profile. The driver is, through use of the present invention, for the first time, presented with multiple bids for insurance premiums that correspond directly to that driver's driving habits. At the same time, the insurance carriers are relieved of the burden of having to create and maintain proprietary PAYD equipment and to install that equipment at the insurers' cost.

With the foregoing and other objects in view, there is provided, in accordance with the invention, a method for determining an insurance premium cost to insure a vehicle. The method includes the step of initiating and establishing a wireless communication link between a vehicle telematics system of the vehicle and a control center remote from the vehicle. The control center has a data center including at least one database server and at least one protocol gateway operable to exchange data with the at least one database server, and a web portal connected to the data center through a communication link. The method includes the step of communicating driver metrics data associated with at least one of the vehicle and a driver of the vehicle from the vehicle telematics system to the data center, analyzing the driver metrics data and creating a driver profile based upon the driver metrics data, and sharing the driver profile with at least one insurance carrier. The at least one insurance carrier assigns a rating to the driver profile based upon the driver metrics data, determines an insurance premium cost to insure the vehicle based upon the assigned rating, and presents the determined insurance premium cost to at least one of an owner of the vehicle and a driver of the vehicle.

In accordance with another feature of the invention, the step of sharing the driver profile is carried out with the at least one insurance carrier by uploading data from the database server to the web portal, the data containing at least one of the driver metrics data, a portion of the driver profile, a metric representing at least a portion of the driver profile, and an entirety of the driver profile and the at least one insurance carrier accessing the data at the web portal.

In accordance with a further feature of the invention, the data accessing step is carried out by restricting access of the web portal to subscriber insurance carriers having a subscription plan with an entity associated with the control center 200.

In accordance with an added feature of the invention, the driver of the vehicle at least one of opts in to allow the at least one insurance carrier to access at least a subset of the driver metrics data and opts out to prevent the at least one insurance carrier from accessing at least a subset of the driver metrics data. This opting step is carried out at the web portal by the driver/owner.

In accordance with an additional feature of the invention, the driver-profile-rating assignment step is carried out by the at least one insurance carrier predicting and assigning an insurance risk associated with the driver profile, where a lower insurance risk is associated with a higher rating and a lower insurance premium cost and a higher insurance risk is associated with a lower rating and a higher insurance premium cost.

In accordance with yet another feature of the invention, a score is assigned to the driver profile at the data center based upon the driver metrics data, the score being a factor used by the at least one insurance carrier in rating the driver profile.

In accordance with yet a further feature of the invention, the at least one insurance carrier includes a plurality of insurance carriers and the step of presenting the insurance premium cost to the driver is carried out by the plurality of insurance carriers participating in a bidding process in which multiple bids for insurance premium cost are presented to the driver from the plurality of insurance carriers.

In accordance with yet an added feature of the invention, the step of communicating driver metrics data is carried out by communicating driver metrics data to the vehicle telematics system from at least one of at least one sensor coupled to at least one of a tire system of the vehicle and a brake system of the vehicle, a speedometer of the vehicle, and an accelerometer of the vehicle.

In accordance with yet an additional feature of the invention, the driver-profile-creating step is carried out by creating multiple driver profiles of multiple drivers associated with the vehicle, each driver profile being associated with a key fob assigned to each driver, and the at least one insurance carrier assigns a rating to each of the multiple driver profiles and determines the insurance premium cost to insure the vehicle based upon the rating assigned to each of multiple driver profiles.

In accordance with again another feature of the invention, the driver metrics data includes information regarding at least one of, vehicle mileage traveled over a period of time, vehicle speed information including at least one of a speed at which the vehicle is driven, a limit of a speed range at which the vehicle is driven, and a speed at which the vehicle turns, vehicle acceleration information, vehicle deceleration information, a geographic location in which the vehicle is driven, a condition of at least one of a vehicle brake system and a vehicle tire system, a time of day the vehicle is driven, and a type of use of the vehicle including one of on-road use and off-road use.

With the objects of the invention in view, there is also provided a system for determining an insurance premium cost to insure a vehicle including a control system remote from the vehicle, communicatively connected to a vehicle telematics system of the vehicle, and having a web portal and a data center. The data center is connected to the web portal through a communication link, has at least one database server, has at least one protocol gateway operable to exchange data with the at least one database server, and is operable to receive and process driver metrics data from the vehicle telematics system, analyze the driver metrics data and create a driver profile based upon the driver metrics data, and share the driver profile with at least one insurance carrier through the web portal.

In accordance with again a further feature of the invention, the web portal is operable to receive an insurance premium cost to insure the vehicle from the at least one insurance carrier and to present the determined insurance premium cost to the driver.

In accordance with again an added feature of the invention, the web portal is operable to allow the driver to opt in to allow the at least one insurance carrier to access at least a subset of the driver metrics data and opt out to prevent the at least one insurance carrier from accessing at least a subset of the driver metrics data.

In accordance with again an additional feature of the invention, the web portal is operable to restrict access thereto only to subscriber insurance carriers having a subscription plan with the control center.

In accordance with still another feature of the invention, the data center is further operable to assign a score to the driver profile based upon the driver metrics data and upload the score to the web portal.

In accordance with still a further feature of the invention, the vehicle includes at least one of the following in communication with the vehicle telematics system at least one sensor coupled to at least one of a tire system of the vehicle and a brake system of the vehicle, a speedometer of the vehicle, and an accelerometer of the vehicle.

In accordance with a concomitant feature of the invention, the data center is operable to create multiple driver profiles of different drivers associated with the vehicle, and further comprising key fobs each assigned to a respective driver, each driver profile being associated with a unique key fob.

Although the invention is illustrated and described herein as embodied in a system and method for obtaining driving metrics and sharing a profile based on the metrics with a plurality of insurance carriers, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram of an exemplary embodiment of a vehicle telematics communications infrastructure utilized with systems and methods of the present invention;

FIG. 2 is a block diagram of an exemplary embodiment of a control center in accordance with the present invention;

FIG. 3 is a chart illustrating an exemplary driver profile in accordance with the present invention; and

FIG. 4 is a diagrammatic representation of an insuring tree sharing the driver profile of FIG. 3 with insurance carriers in accordance with an exemplary embodiment of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The advent of telematics services, which were introduced over a decade ago, brought with it a trend to incorporate the ability of a vehicle to communicate with remote control centers and transmit location data and vehicle information related to safety, security, and emergency breakdown. “Telematics,” as it is referred to in the art, includes the integration of wireless communications, vehicle monitoring systems, and location devices. Such technologies in automotive communications combine wireless voice and data capability for management of information and safety applications. “Telematics,” as used herein, refers to any integrated use of telecommunications and “informatics,” which is the study, design, development, implementation, support or management of computer-based information systems, particularly software applications and computer hardware. “Remote control centers” or “remote control systems” as used herein, refer to off-board systems in communication with the vehicle, the components of which can be, but are not necessarily, located at a central or same location. Alternatively, the components of the remote control centers may be located at various separate locations and connected through wired and wireless communication links. Through telematics, the present invention allows the sending, receiving, and storing of information through telecommunication devices between the vehicular systems and remote control centers. The telematics of the present invention includes, but is not limited to, Global Positioning System (GPS) technology integrated with computers and mobile communications technology in automotive navigation systems.

Most of the early telematics communication was achieved through wireless voice channels that were analog in nature. By law, telecommunications carriers were no longer required to support analog connectivity and, as a result, the industry moved to digital connectivity and, consequently, data connectivity, such as “3G” technology, became a readily available measure for mobile devices to “connect” to the Internet. As a result of these advances, the vehicle is also being adapted to leverage data connectivity in combination with voice channel connectivity in what is referred to as the “connected car” concept.

The “connected car” concept has continued to evolve over the past few years and commercial launches of rather sophisticated vehicle services are becoming a reality. These services often rely on vehicle location and “on cloud computing,” defined as web services accessed over a data channel. Examples of these services include off-board routing, destination capture, remote-vehicle diagnostics, music downloads, traffic reporting, local searches, access to concierge services, connecting to a vehicle dealer, and roadside assistance. The term “off-board” as used herein refers to a location away from and outside the vehicle. The term “local search” as used herein refers to a point-of-interest (POI) search based on proximity to a specific location. The examples given above are regarded as being vehicle-centric in nature and many invoke some form of vocal communication with a live agent or an off-board interactive automation system.

The present invention provides a novel and efficient system and method for obtaining driving metrics and sharing a driver or vehicle profile based on the metrics with a plurality of insurance carriers. Embodiments of the invention provide telematic driver/vehicle usage metric systems capable of capturing a detailed set of metrics. In addition, embodiments of the invention provide a driver or vehicle profile based on the captured metrics and allow participating insurance carriers to view the profile and offer insurance premium pricing based on the metrics contained within the profile.

In accordance with features of the present invention, the insured controls whether or not his or her driving information is shared with insurance companies. This provides a tremendous advantage over the prior art, where, once the insured agrees to participate in the PAYD system, the insurance carrier is provided full access to the insured's driving metrics. It is only with the present invention that data, or driver statistics, are proactively shared at the driver's discretion. This aspect of the present invention is advantageous since the driver will have a sense, from their accumulated profile, as to whether sharing this data will help secure a lower premium. To the contrary, if a driver believes that their data will not help secure a lower premium, he or she can choose to keep their driver profile private. Stated differently, existing solutions are reactive while the present invention is proactive.

In accordance with an exemplary embodiment of the present invention, a remote control center utilizes the driver profile to create a driver score or rating, where the driver score is analogous to a credit score. This driver score, with the permission of the driver, can be provided to one or more insurance carriers as a basis for the insurance carriers to determine an associated insurance risk for that particular driver.

In accordance with aspects of the present invention, a driver's insurance premiums can be dynamically adjusted based on changes to the driver's driving habits. Therefore, a positive aspect of the present invention provides a strong motivation for the driver to exercise caution and control when driving, as well as an incentive to drive less.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

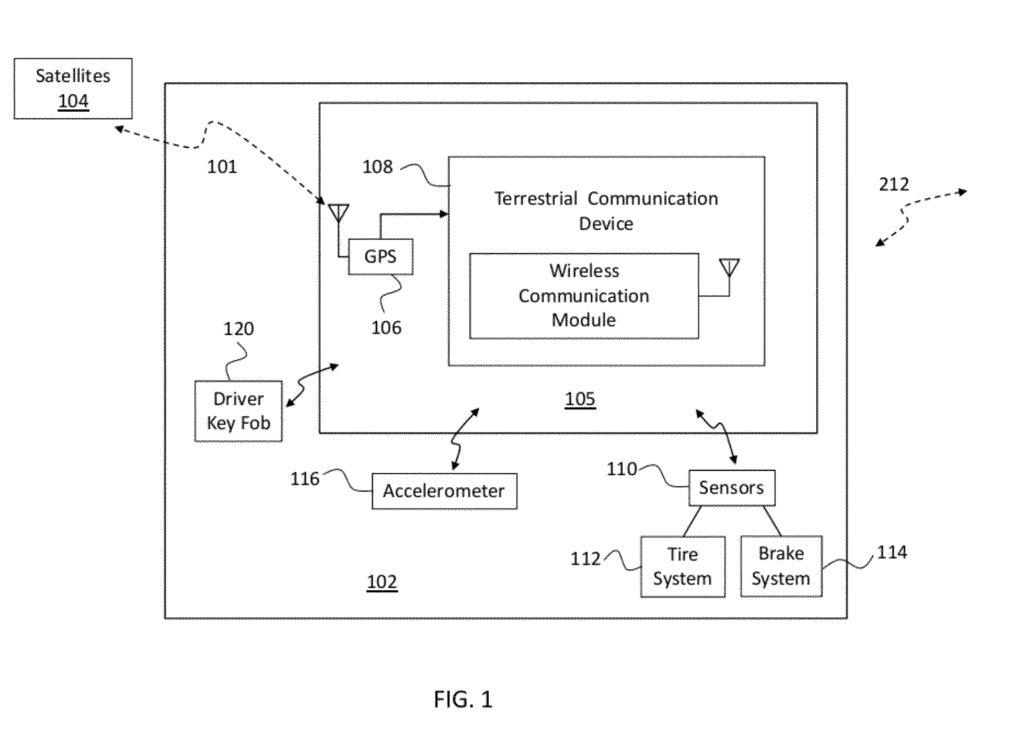

Described now are exemplary embodiments of the present invention. Referring now to the figures of the drawings in detail and first, particularly to FIG. 1, there is shown a first exemplary embodiment of a telematics communications infrastructure utilized with systems and methods of the present invention. FIG. 1 shows several advantageous features of the present invention, but, as will be described below, the invention can be provided in several combinations of features and components, and varying numbers and functions of the components. FIG. 1 depicts an exemplary embodiment of the present invention where an asset or vehicle 102, e.g., an automobile, receives GPS signals through a wireless communication link 101 established with a plurality of satellites 104. The vehicle 102 is equipped with a telematics system 105 including a GPS navigation receiver 106 and a terrestrial communication device 108 including a wireless communication module, e.g., devices operable on GSM (Global System for Mobile Communications), CDMA (Code Division Multiple Access), one of the cellular wireless standards, i.e., 2G, 3G, or 4G, an SMS sender, and others. Through its use of GPS technology, the present invention is able to precisely monitor the location, movement, status, and behavior of the vehicle 102 and to communicate this data outside the vehicle 102. The GPS navigation system receiver 106 and the terrestrial communication device 108 are typically devices housed within the vehicle 102 and not obviously visible to a driver.

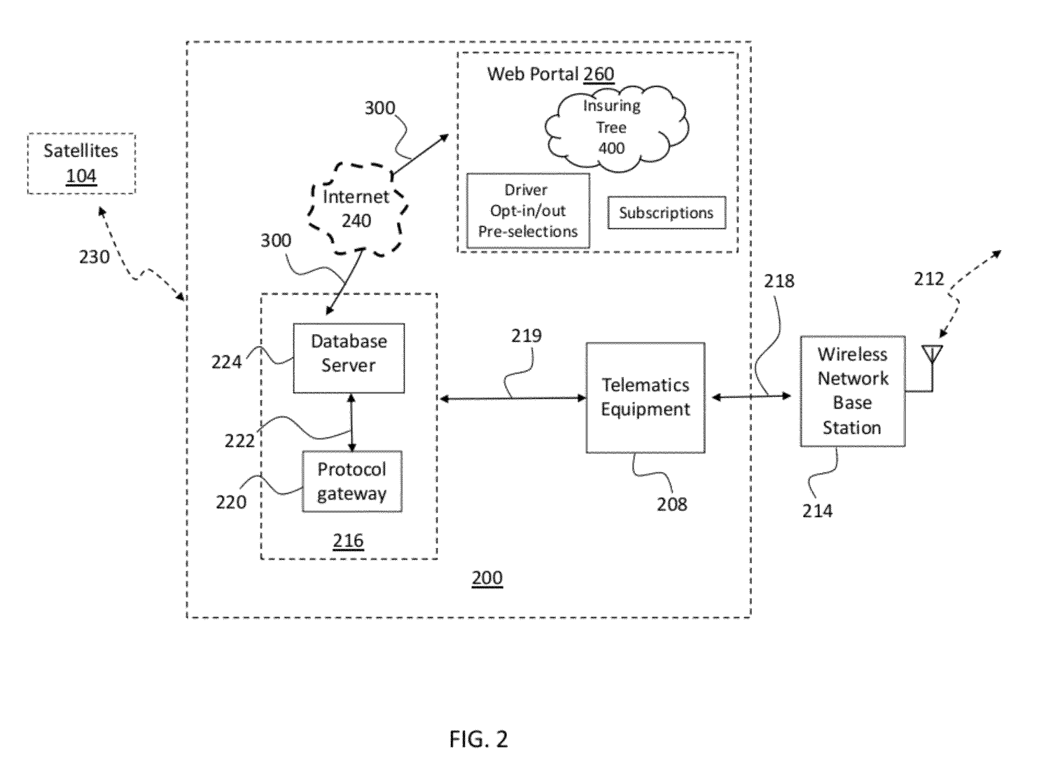

As provided in FIGS. 1 and 2, the vehicle telematics system 105 interfaces with an exemplary remote control center 200 through a wireless communication link 212 established with at least one wireless network base station 214. The control center 200 interfaces with at least one wireless network base station 214 directly and/or wirelessly through a communication link 218. As shown in FIG. 2, the exemplary control system 200 includes a data center 216 in bidirectional communication with telematics service provider equipment 208 directly and/or wirelessly through a communication link 219. As indicated by the dashed-line box enclosing the control center 200, the control center 200 may be an integrated system, wherein the service provider telematics equipment 208, the data center 216, and the web portal 260 (described below in further detail) are located at the same location, for example, at a facility operated by the telematics service provider. Alternatively, as illustrated with the dashed-line boxes enclosing each of the data center 216 and the web portal 260, each may be remote (i.e., located at a separate location) from the telematics equipment 208 provided by the telematics service provider. In any event, the data center 216 is remote from the vehicle 102 and may, therefore, be referred to herein as a “remote data center” 216.

According to the present exemplary embodiment, the terrestrial communication device 108 of the vehicle telematics system 105 works in conjunction with the telematics provider equipment 208 to provide an owner with telematics services such as telephone interconnect, short message service (SMS) via a short message service center (SMSC), dispatch and/or instant conferencing, circuit data, packet data, combinations thereof, as well as other data services from the provider.

The data center 216, through a protocol gateway 220, exchanges data 222 with one or more database servers 224. The database servers 224 facilitate execution of PC or web-based software that turns the data 222 into information that is utilized by systems and methods of the invention in conjunction with computerized mapping and vehicle tracking software.

It should be noted that the invention is in no way limited to the infrastructure illustrated in FIG. 1 and described above. The present invention contemplates any known or to-be-developed communication systems and methods for obtaining information pertaining to driving metrics and conditions of a vehicle 102 and communicating the information to a remote control center 200. As one example, indicated by the dashed-line arrow 230, the control center 200, for example, the remote data center 216 thereof, can communicate directly with one or more of the plurality of satellites 104, which, in turn, communicates directly with a GPS transceiver 106 of a vehicle telematics system 105.

In accordance with embodiments of the present invention, during operation of the vehicle 102, the GPS receiver 106 is in constant or regular communication with the plurality of GPS satellites 104 and communicates terrestrial positioning information pertaining to the vehicle 102 and its movements to the data center 216. The exemplary control center 200 is operable to receive from the vehicle telematics system 105 location information and other driving metrics data 222 through communication links 212 and 218. The driving metrics data 222 includes, for example, the distance the vehicle 102 is driven each driving session, the speed or limits of a speed range the vehicle 102 is driven, acceleration rates, deceleration rates, speed upon which the vehicle 102 turns, the geographic locations in which the vehicle 102 is driven, the time of day a vehicle 102 is driven, whether the vehicle 102 is used for off-road use, where the vehicle 102 is parked, age and health (i.e., condition) of the vehicle 102, and other data relevant to insurance-premium determinations, which may vary on a vehicle-by-vehicle basis depending on the hardware and tracking capabilities of the individual telematics system 105.

Information pertaining to the health or condition of a vehicle 102 that could be relevant to insurance-premium determinations includes, for example, information regarding the wear on the vehicle tire or brake systems. Rapid wear on either the tire system 112 or the brake system 114 may tend to indicate a high-risk driver; whereas, brakes or tires that last longer than expected can be an indication of a low-risk driver. Therefore, as illustrated in FIG. 1, one exemplary embodiment of the present invention includes one or more sensors 110 coupled to one or more tires of a vehicle tire system 112. These sensors 110 are able to communicate tire wear to the data center 216 through communication with the vehicle telematics system 105. The data center 216 can utilize this data 222 to create a driver profile 300 that is potentially even more indicative of the driver's driving habits and which can be stored and maintained by the database servers 224.

For instance, if the front tires of a front-wheel drive automobile 102 are showing a great deal of wear sooner than expected, this can be an indication of a driver that accelerates or brakes too quickly. These driving habits tend to show a driver that is likely to be involved in an accident, especially if these habits are employed during inclement weather. Similarly, at least one sensor 110 can be coupled to the brake system 114 and can report back to the data center 216 through communication with the vehicle telematics system 105. If the driver profile 300 shows brakes that wear out more quickly than expected, this can be interpreted as a high-risk driver. In addition, the driver can be alerted to any issues involving tire or brake wear, which can ensure safety and further reduce the cost of insurance.

As shown in FIG. 2, the data center 216 advantageously converts the acquired metrics data 222 into a vehicle or driver profile 300. As used herein throughout the instant application, the terms “vehicle profile” and “driver profile” are interchangeable, i.e., the present invention utilizes substantially the same systems and methods to create profiles based on either a particular driver or a particular vehicle.

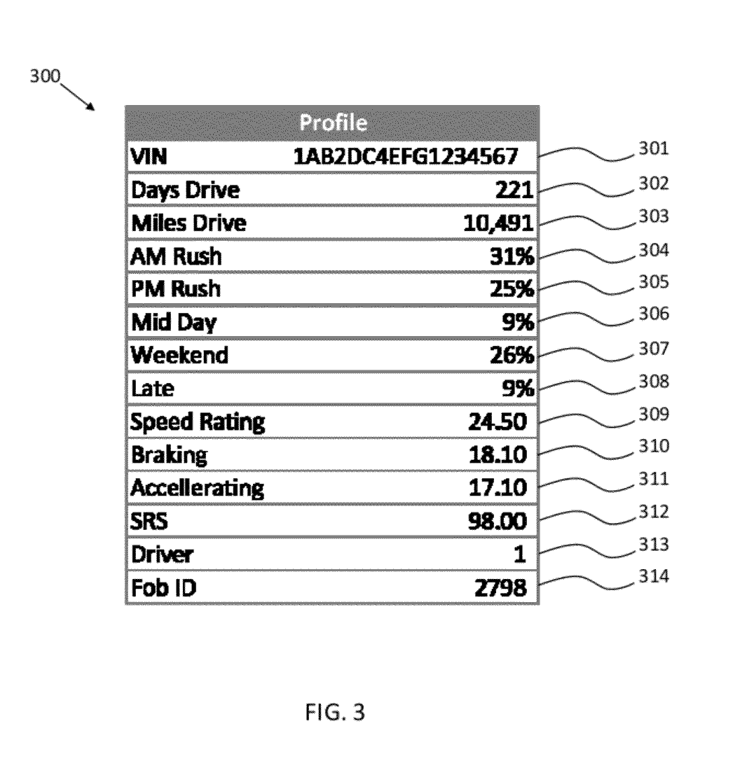

FIG. 3 provides an exemplary profile 300 that includes captured driving metrics for a particular vehicle/driver 102. The exemplary driver profile 300 includes a first field 301 identifying the vehicle by a VIN number. A second field 302 within the profile 300 indicates the days the vehicle 102 was driven. A third field 303 indicates the number of miles that were driven during a particular profile period. Fields 304, 305, 306, 307, 308 indicate the percentage of time that the driver or vehicle 102 is driving in morning rush hour traffic, driving in evening rush-hour traffic, driving during the midday traffic, driving on the weekend, and driving late at night, respectively. Field 309 provides an exemplary rating that is assigned to the vehicle/driver based on the driver's recorded speeds during driving sessions. Fields 310 and 311 provide braking and acceleration ratings, respectively, based on the drivers recorded metrics during driving sessions. It should be noted, that in addition to GPS monitoring of the vehicle's movements, other devices, such as an accelerometer 116, can be used to provide driving feedback to the data center 216 through communication with the vehicle telematics system 105. The exemplary accelerometer 116 is operable to measure three-dimensional acceleration ((x, y, z); (3, −4, 2)) so that jumps, bottoming out and cornering of the vehicle 102 can be determined. A field 312 provides an SRS rating. A particular driver of the vehicle is identified in field 313 and exemplary field 314 provides a key fob identifier.

It should be noted that the fields 301 through 314 provided in the profile 300 of FIG. 3 are merely exemplary fields. The invention in no way requires all of these fields, nor is it limited to the fields shown and described herein. The invention is intended to include any metric data 222 that could impact an insurance carrier's decision on insurance-policy-premium pricing. In addition, although multiple data can be collected, not all of the data needs to be used to determine an insurance premium. For instance, some insurance carriers may only find the miles driven in a period of time to be a relevant factor in determining the premium. Moreover, in an exemplary embodiment, the driver may only grant access to a particular pre-defined subset of driver metrics data, thereby limiting the fields of the created driver profile 300.

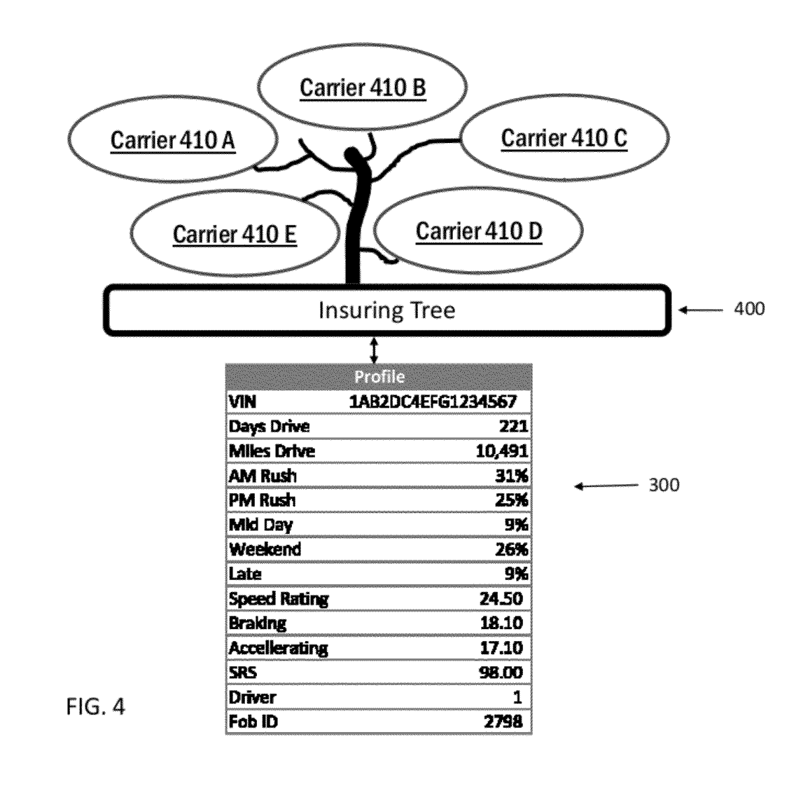

Referring now to FIGS. 2 and 4, advantageously, the present invention allows the driver metrics profile 300 to be “portable.” That is, in accordance with an embodiment, the profile 300 can be uploaded from the database server 224 into what is referred to herein as an “insuring tree” 400 that is accessible to multiple insurance carriers 410 A-E. As best illustrated in FIG. 2, multiple insurance carriers 410 A-E can access the insuring tree 400 via a network, for instance, the Internet 240. In this exemplary embodiment, the insuring tree 400 is uploaded to a web portal 260 that is accessible to the insurance carriers 410 A-E through the Internet 240.

In an exemplary embodiment, insurance carrier access to the insuring tree 400 hosted on the web portal 260 is restricted, for example, by way of subscription or through password entry. For instance, only insurance carriers 410 A-E having a subscription plan with, for example, the operator of the control center 200 can access the insuring tree 400 through the web portal 260 to provide a competitive quote to drivers.

In accordance with the present invention, the insurance carriers 410 A-E can view the driver profile 300, predict an insurance risk associated with the profile 300, and determine what premium rate, if any, to offer a driver associated with the driver profile 300. If two or more of the insurance carriers 410 A-E determine appropriate rates, the carriers 410 A-E can participate in a bidding process. The inventive insuring tree 400 advantageously provides the driver associated with the driver profile 300 with, for the first time ever, a selection of rates customized to that driver's driving habits and presented in the exemplary insuring tree 400. In addition, the driver associated with the driver profile 300, unlike with prior-art PAYD systems, knows his or her rates prior to obtaining service from a particular insurance carrier 410 A-E.

In an exemplary embodiment, a driver may opt-in or opt-out of participation with the inventive system. In addition, the driver can preselect which driving metrics data he or she wants shared in his or her driver profile 300. Thus, the driver can opt-out of sharing a sub-set of driving metrics data 222 and/or opt-in to sharing only a sub-set of driver metrics data 222. Advantageously, the driver has control over what driving metrics data 222 (i.e., none, all, or a preselected subset) are monitored, accessed, and maintained by the control center 200 and shared with various insurance carriers 410 A-E. In an exemplary embodiment, the driver can opt-in/out and preselect the driving metrics data to be shared in his or her driver profile 300 through the web-portal 260, for example, through a series of drop-down menus.

The insurance carriers 410 A-E can develop their own ranking system to score the driver profiles 300, based upon the particular driver metrics data shared in the driver profile 300, in order to calculate a unique insurance premium rate for the driver associated with the driver profile 300. Through the web portal 260, the insurance carriers 410 A-E can select certain driver profiles 300 to which it wants to offer a quote.

Because the present invention can be implemented through a third party remote control center 200, the invention advantageously allows drivers to remain in control of their profile 300. That is, the driver can determine who, if anyone, is granted access to their profile 300 or portions of their profile 300. In contrast with the prior-art PAYD systems, where the customer or driver insures with an insurance carrier 410 A-E that supplies its own metrics-collection device and monitoring service, the driver cannot prevent the information contained in the driver profile from being collected by the insurance carrier 410 A-E. It is only with the present invention that data, or driver statistics, are proactively shared at the insured's or driver's discretion. This aspect of the present invention is advantageous since the driver will have a sense, from their accumulated profile 300, that sharing this data will help them secure a lower premium. To the contrary, if a driver believes that their data will not help them secure a lower premium, they can choose to keep their driver profile 300 private. Stated differently, existing solutions are reactive while the present invention is proactive.

Furthermore, with prior art systems, the monitored and collected driving data remained with the particular insurance carrier providing the equipment and monitoring service. This monopoly on the driver's metrics information created a barrier for other carriers. However, through utilization of embodiments of the present invention, for the very first time, drivers are given the choice to share their profile information with multiple insurance carriers 410 A-E to solicit competitive bids for premium rates.

In addition, embodiments of the present invention provide an inventive algorithm that can be used to score the data 222 collected through the inventive system. This algorithm could be analogized to a credit score. As described above, the insurance carriers 410 A-E could then subscribe to an inventive system that collects, maintains, and shares these driving scores through the web portal 260 as a way to determine appropriate premiums to charge particular drivers.

As provided above, “driver profile” may be interchangeable with “vehicle profile,” as the present invention is not limited to a single driver or the vehicle owner. In typical families, for example, more than one person may drive a particular vehicle 102. Thus, as illustrated in FIG. 1, an exemplary embodiment of the present invention includes a key fob 120 assigned to each individual driver. The key fob 120 is identified by a key fob id, as illustrated in field 314 of the exemplary driver profile 300 of FIG. 3, and interfaces with the vehicle telematics system 105. If each driver is assigned their own key fob 120, then the metrics can be expanded to include multi-driver profiling based on the unique key fob 120 identification by the vehicle telematics system 105.

In another exemplary embodiment, the control center 200 is operable to detect situations in which the driver attempts to trick the system by providing false driver metrics data 222 in an effort to create a more desirable driver profile 300 to the insurance carriers 410 A-E. For instance, a driver may hook an ignition interrupt device into the telematics system 105, for example, to trick the telematics system 105 into reporting to the data center 216 and/or the telematics equipment 208 of the control center 200 that the ignition of the vehicle 102 is turned “off.” The driver may then drive long distances or drive recklessly with the belief that the extra miles or reckless driving will not be reported in his driver profile 300 since the ignition is being (falsely) reported as “off.” An exemplary embodiment of the present invention includes a control center 200 operable to detect such attempted bypass or “gaming” of the system. For example, the control center 200 is constantly receiving GPS location information from the vehicle telematics system 105. It can compare this location information with the duration of time the ignition is “off.” If there is a questionable mismatch, for example, the ignition was “off” during the time the vehicle 102 moved from location A to location B, the control center 200 can detect this mismatch and provide this information to the insurance carriers 410 A-E. The insurance carrier 410 A-E can then use this information in its rating of the driver profile 300 or it may choose to investigate the situation further.

An inventive system and method has been disclosed that provides for accurate capturing of relevant driver data, conversion of the relevant driver data to a profile, and sharing of the profile with multiple insurance carriers for the purpose of providing accurate insurance premium rates. In addition, the invention advantageously encourages drivers to exercise caution and control by incentivizing them with lower insurance premiums as a reward for safe driving. Furthermore, insurance premiums are advantageously paid in proportion to a driver's propensity to have insurance claims.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for determining an insurance premium cost to insure a vehicle, the method comprising:
initiating and establishing a wireless communication link between:
a vehicle telematics system of the vehicle; and
a control center remote from the vehicle, the control center having:
a data center including:
at least one database server; and
at least one protocol gateway operable to exchange data with the at least one database server; and
a web portal connected to the data center through a communication link;
communicating driver metrics data associated with at least one of the vehicle and a driver of the vehicle from the vehicle telematics system to the data center;
analyzing the driver metrics data and creating a driver profile based upon the driver metrics data;
sharing the driver profile with at least one insurance carrier;
the at least one insurance carrier:
assigning a rating to the driver profile based upon the driver metrics data; and
determining an insurance premium cost to insure the vehicle based upon the assigned rating; and
presenting the determined insurance premium cost to at least one of an owner of the vehicle and a driver of the vehicle.

2. The method according to claim 1, which further comprises carrying out the step of sharing the driver profile with the at least one insurance carrier by:
uploading data from the database server to the web portal, the data containing at least one of the driver metrics data, a portion of the driver profile, a metric representing at least a portion of the driver profile, and an entirety of the driver profile; and
the at least one insurance carrier accessing the data at the web portal.

3. The method according to claim 2, which further comprises carrying out the data accessing step by restricting access of the web portal to subscriber insurance carriers having a subscription plan with an entity associated with the control center.

4. The method according to claim 1, which further comprises the driver of the vehicle at least one of:
opting in to allow the at least one insurance carrier to access at least a subset of the driver metrics data; and
opting out to prevent the at least one insurance carrier from accessing at least a subset of the driver metrics data.

5. The method according to claim 4, which further comprises executing the at least one opting step at the web portal by the driver.

6. The method according to claim 1, which further comprises carrying out the driver-profile-rating assignment step by the at least one insurance carrier predicting and assigning an insurance risk associated with the driver profile, wherein:
a lower insurance risk is associated with a higher rating and a lower insurance premium cost; and
a higher insurance risk is associated with a lower rating and a higher insurance premium cost.

7. The method according to claim 1, which further comprises assigning a score to the driver profile at the data center based upon the driver metrics data, the score being a factor used by the at least one insurance carrier in rating the driver profile.

8. The method according to claim 1, wherein:
the at least one insurance carrier includes a plurality of insurance carriers; and
the step of presenting the insurance premium cost to the driver is carried out by the plurality of insurance carriers participating in a bidding process in which multiple bids for insurance premium cost are presented to the driver from the plurality of insurance carriers.

9. The method according to claim 1, wherein the step of communicating driver metrics data is carried out by communicating driver metrics data to the vehicle telematics system from at least one of:
at least one sensor coupled to at least one of:
a tire system of the vehicle; and
a brake system of the vehicle;
a speedometer of the vehicle; and
an accelerometer of the vehicle.

10. The method according to claim 1, which further comprises:
carrying out the driver-profile-creating step by creating multiple driver profiles of multiple drivers associated with the vehicle, each driver profile being associated with a key fob assigned to each driver; and
the at least one insurance carrier:
assigning a rating to each of the multiple driver profiles; and
determining the insurance premium cost to insure the vehicle based upon the rating assigned to each of multiple driver profiles.

11. The method according to claim 1, wherein the driver metrics data includes information regarding at least one of:
vehicle mileage traveled over a period of time;
vehicle speed information including at least one of:
a speed at which the vehicle is driven;
a limit of a speed range at which the vehicle is driven; and
a speed at which the vehicle turns;
vehicle acceleration information;
vehicle deceleration information;
a geographic location in which the vehicle is driven;
a condition of at least one of:
a vehicle brake system; and
a vehicle tire system;
a time of day the vehicle is driven; and
a type of use of the vehicle including one of on-road use and off-road use.

12. A system for determining an insurance premium cost to insure a vehicle, the system comprising:
a control center remote from the vehicle, communicatively connected to a vehicle telematics system of the vehicle, and including:
a web portal; and
a data center:
connected to the web portal through a communication link;
including at least one database server;
including at least one protocol gateway operable to exchange data with the at least one database server; and
being operable to:
receive and process driver metrics data from the vehicle telematics system;
analyze the driver metrics data and create a driver profile based upon the driver metrics data; and
share the driver profile with at least one insurance carrier through the web portal.

13. The system according to claim 12, wherein the web portal is operable:
to receive an insurance premium cost to insure the vehicle from the at least one insurance carrier; and
to present the determined insurance premium cost to the driver.

14. The system according to claim 12, wherein the web portal is operable to allow the driver to at least one of:
opt in to allow the at least one insurance carrier to access at least a subset of the driver metrics data; and
opt out to prevent the at least one insurance carrier from accessing at least a subset of the driver metrics data.

15. The system according to claim 12, wherein the web portal is operable to restrict access thereto only to subscriber insurance carriers having a subscription plan with the control center.

16. The system according to claim 12, wherein the data center is further operable to:
assign a score to the driver profile based upon the driver metrics data; and
upload the score to the web portal.

17. The system according to claim 12, wherein the vehicle includes at least one of the following in communication with the vehicle telematics system:
at least one sensor coupled to at least one of:
a tire system of the vehicle; and
a brake system of the vehicle;
a speedometer of the vehicle; and
an accelerometer of the vehicle.

18. The system according to claim 12, wherein the data center is operable to create multiple driver profiles of different drivers associated with the vehicle, and further comprising key fobs each assigned to a respective driver, each driver profile being associated with a unique key fob.

19. The system according to claim 12, wherein the driver metrics data includes information regarding at least one of:
vehicle mileage traveled over a period of time;
vehicle speed information including at least one of:
a speed at which the vehicle is driven;
a limit of a speed range at which the vehicle is driven; and
a speed at which the vehicle turns;
vehicle acceleration information;
vehicle deceleration information;
a geographic location in which the vehicle is driven;
a condition of at least one of:
a vehicle brake system; and
a vehicle tire system;
a time of day the vehicle is driven; and
a type of use of the vehicle including one of on-road use and off-road use.
